(19) United States
(12) Patent Application Publication
(10) Pub. No.: US 2018/0248400 A1
(43) Pub. Date: Aug. 30, 2018

(54) SOLAR-POWERED SYSTEM FOR A TRAFFIC SIGNAL

(71) Applicant: Greg Emmorey, Grand Rapids, MI (US)

(72) Inventor: Greg Emmorey, Grand Rapids, MI (US)

(21) Appl. No.: 15/441,524

(22) Filed: Feb. 24, 2017

(51) Int. Cl. H02J 7/35; G08G 1/095

(52) U.S. Cl. CPC H02J 7/35; G08G 1/095

(57) ABSTRACT

A system for sustaining traffic signal power that includes: a support pole; a solar panel mounted on the top of the support pole; and a battery. The battery is mounted on the support pole and is charged via the solar panel. A traffic signal connects to the battery and solar panel via a power line adapted to suspend the traffic signal, wherein the power line extends from the support pole to traffic signal.

### BACKGROUND OF THE INVENTION

### Field of Invention

The present invention relates to a solar energy supply system for a traffic signal.

### Description of Related Art

Traffic signals are implemented to control traffic flow through various intersections in a normal street grid. The traffic signals control the flow of traffic and helps to ensure that vehicles safely travel across intersections without the occurrence of an accident. The traffic signals are essentially controlling the flow of traffic in order to maintain a reasonable flow of traffic through the traffic grid. Traffic signals are powered through electrical power and as a result are dependent upon electrical power for proper functioning. If a power outage should occur traffic signals become non-functional and create serious hazards for vehicle traffic. As a result, it would be advantageous to have a system implemented that provides sufficient backup power at the time of a primary power outage. Such a system could ensure that traffic signals remain properly operating at the time of a power outage.

Examples of prior art solar-powered traffic signals are disclosed in U.S. Patent Publication No. 2007/0126599 to Gembala, wherein a traffic signal apparatus includes a solar panel's battery source for powering the directional signals during a power outage and the charge is linked to the solar panels for re-energizing the battery source. The batteries of this Gembala reference are shown at the bottom of a ground-mounted traffic signal with solar panels at the top of the traffic signal. U.S. Pat. No. 5,898,389 to Deese discloses an auxiliary battery backup for a traffic signal. This auxiliary backup system is limited to a single battery supply unit. U.S. Pat. No. 4,200,904 to Doan discloses a solar-powered street lighting system that is totally independent of any external power supply. The solar power is used as the primary power supply with a generator provided as a backup power source.

### SUMMARY OF THE INVENTION

The present invention relates to a system for sustaining traffic signal power that includes: a support pole; a solar panel mounted on the top of the support pole; and a battery. The battery is mounted on the support pole and is charged via the solar panel. A traffic signal connects to the battery and solar panel via a power line adapted to suspend the traffic signal, wherein the power line extends from the support pole to traffic signal.

### BRIEF DESCRIPTION OF DRAWINGS

FIG. 1 depicts a solar-powered traffic system according to the present invention.

### DETAILED DESCRIPTION

The present invention relates to the system that uses the solar power as a backup power supply for a traffic signal. The present invention contemplates the use of a support pole to support a traffic signal over an intersection. A solar panel and a battery are mounted at the top of the support pole. The solar panel charges the battery and ensures that the battery remains charged to supply power to a traffic signal suspended from the support pole.

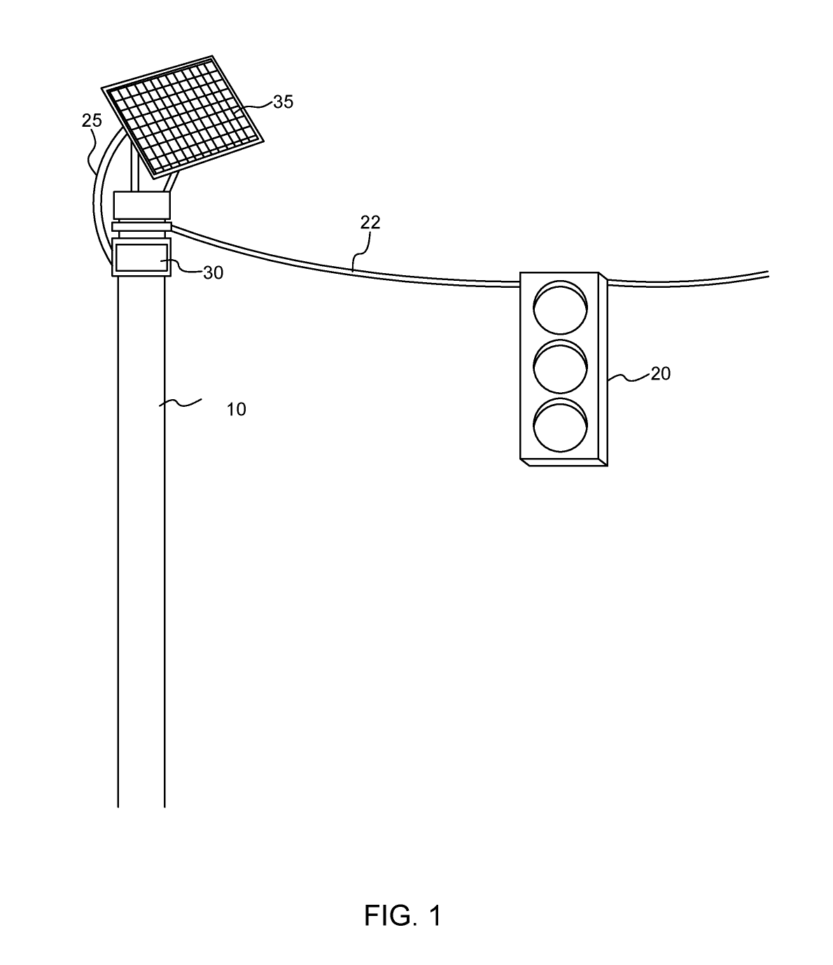

In reference to FIG. 1, the system for sustaining traffic signal power is depicted. In the system, a Traffic Signal 20 is suspended on a Support Pole 10 through a Power Line 22. The Power Line 22 connects to a Battery 30 mounted at the top of the Support Pole 10. Also mounted on top of the Support Pole 10 is a Solar Panel 35. The Solar Panel 35 connects to the Battery 30 with Power Lines 25 shown in FIG. 1. The Solar Panel 35 includes a number of collectors to receive solar power and supply power to the Battery 30. The Battery 30 operates as a backup system for power to the Traffic Signal 20. Primary power is supplied through the traditional electrical grid to the Traffic Signal 20. Upon disconnection of this principal power the Battery 30 and Solar Panel 35 activate to provide sufficient power to a traffic signal for operation.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A system for sustaining traffic signal power comprising:
a. a support pole;
b. a solar panel mounted on the top of the support pole;
c. a battery, wherein the battery is mounted on the support pole and is charged via the solar panel;
d. a traffic signal connected to the battery and solar panel; and
e. a power line adapted to suspend the traffic signal, wherein the power line extends from the support pole to traffic signal.
